(19) United States
(12) Patent Application Publication
(10) Pub. No.: US 2018/0027436 A1
(43) Pub. Date: Jan. 25, 2018

(54) RADIO HEALTH MONITORING

(71) Applicant: Aruba Networks, Inc., Sunnyvale, CA (US)

(72) Inventors: Pradeep J. Iyer, Sunnyvale, CA (US); Manaswini Lakshmikanth Sugatoor, Bangalore (IN); Gopal Agarwal, Bangalore (IN); Brijesh Kumar Yadav, Bangalore (IN)

(21) Appl. No.: 15/216,776

(22) Filed: Jul. 22, 2016

(51) Int. Cl. H04W 24/08; H04L 1/20; H04L 12/26

(52) U.S. Cl. CPC H04W 24/08; H04L 43/065; H04L 1/203; H04L 1/0061

(57) ABSTRACT

Examples relate to radio health monitoring. One example relates to a system for radio health monitoring. They system may comprise a physical processor implementing machine readable instructions stored on a non-transitory machine-readable storage medium that cause the system to determine whether a radio in a wireless network has high utilization, responsive to determining that the radio has high utilization, determine a root cause for the high utilization, and provide an alert comprising information about the radio, the high utilization, and the determined root cause.

### BACKGROUND

A radio in a wireless network may comprise a transmitter and a receiver to send and receive radio signals for broadcast. A radio may send and receive signals over a channel, but may sometimes have less than ideal operation due to operating issues such as interference, floor noise, or other issues.

### BRIEF DESCRIPTION OF THE DRAWINGS

The following detailed description references the drawings, wherein:

FIG. 1 is a block diagram of an example system for radio health monitoring;

FIG. 2 is a block diagram of an example system for radio health monitoring;

FIG. 3 is a flowchart of an example method for radio health monitoring; and

FIGS. 4A, 4B, and 4C are flowcharts of example methods for radio health monitoring.

### DETAILED DESCRIPTION

The following detailed description refers to the accompanying drawings. Wherever possible, the same reference numbers are used in the drawings and the following description to refer to the same or similar parts. While several examples are described in this document, modifications, adaptations, and other implementations are possible. Accordingly, the following detailed description does not limit the disclosed examples. Instead, the proper scope of the disclosed examples may be defined by the appended claims.

As mentioned above, a radio in a wireless network may comprise a transmitter and a receiver to send and receive radio signals for broadcast in a wi-fi range. A radio may send and receive signals over a channel. The channel may be made available to the radio via an access point.

An access point in a wireless network may comprise a hardware device that makes available one or multiple channels via which radios can access the wireless network. An access point may be identified by a MAC address and a SSID, and may communicate with other access points in the wireless network to facilitate radio communication. An access point may sense radios, negotiate with radios to facilitate connection of the radio over the wireless network, may facilitate the establishment of session for radio communication with packets flowing to and from the radio via the wireless network, and/or otherwise facilitate communication to and from the radio via the wireless network. By facilitating radio communication, the access point may also determine information about each radio that communicates over a channel of the access point.

In some examples, an access point may have multiple channels, with each channel facilitating radio communication from one or multiple radios. In some examples, a channel may have multiple access points available for connection to a radio. The access points on a channel may be of a same type or different types.

A radio transmitting signals over a channel of an access point may sometimes have less than ideal operation due to operating issues such as interference, floor noise, or other issues. In fact, it may be relatively simple to determine whether a radio has high utilization or high noise floor. Utilization of a radio may comprise, for example, a percentage of the channel used for throughput. High utilization may be determined by a radio using a percentage of the channel above a predetermined threshold. A noise floor comprises the amount of signal created from all of noise sources and unwanted signals that are being measured, where noise comprises any signal other than the one being monitored for communication purposes. A high noise floor may be determined by a radio having an amount of noise above a predetermined threshold.

High utilization and high noise floor may arise from appropriate usage of the radio, or may result from issues that the radio is experiencing. Given that, it may be unclear from a determination of high utilization and/or high noise floor as to whether a radio has a capacity issue, if there has been bad rf planning for a connected network of radios, or if another issue exists. To that end, it is technically challenging to determine a root cause of the high utilization and/or high noise floor of a radio.

A new technical solution to this technical challenge determines the root cause of high utilization and/or high noise floor of a radio and facilitates the provision of alerts that include information related to the root cause. This technical solution involves monitoring radio health of radios at predetermined time intervals, identifying a radio as a problem radio if it is consistently reporting high utilization and/or high noise floors, identifying the root cause for the identified issue(s), and providing an alert for each radio experiencing a problem, where the alert includes information about the radio, the problem, and its root cause(s).

A computer system implementing radio health monitoring may determine whether a radio in a wireless network has a high utilization and/or high floor noise. The high utilization and/or high floor noise may be indicative of a health problem for the radio. The system may also determine a root cause of the high utilization and/or high floor responsive to determining that the radio has high utilization and/or high floor noise. The system may provide an alert comprising information about the radio, the determined high utilization and/or high floor noise, and the determined root cause(s).

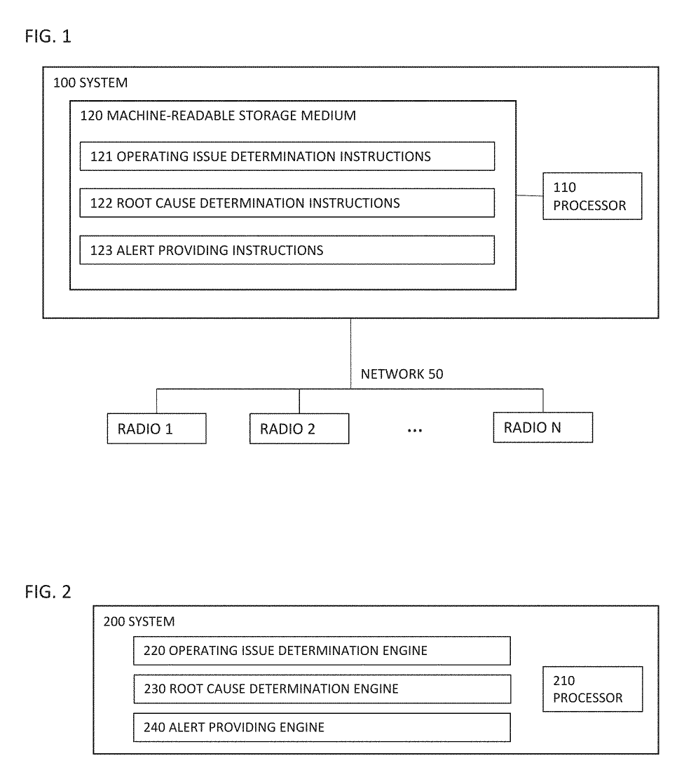

Referring now to the drawings, FIG. 1 is a block diagram of an example system 100 for radio health monitoring. In the example depicted in FIG. 1, system 100 includes a non-transitory machine-readable storage medium 120 and a processor 110.

Referring now to the drawings, FIG. 1 is a block diagram of an example system 100 for radio health monitoring. System 100 may comprise a radio, access point, wireless server, mainframe, notebook, desktop, tablet, workstation, mobile device, network controller, and/or any other device suitable for executing the functionality described below. In the example of FIG. 1, system 100 includes a non-transitory machine-readable storage medium 120 and a processor 110.

System 100 may be communicably connected to a set of radios (e.g., radio 1, radio 2, . . . , radio N). A radio (e.g., radio N) may comprise a hardware device including a receiver and a transmitter to send and receive communications over a wi-fi range in a network. System 100 may be connected to a set of radios via a network 50. Network 50 may comprise any infrastructure or combination of infrastructures that enable electronic communication between the components. For example, network 50 may include at least one of the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. According to various implementations, system 100 and the various components described herein may be implemented in hardware and/or a combination of hardware and programming that configures hardware. Furthermore, in FIG. 1 and other Figures described herein, different numbers of components or entities than depicted may be used.

Processor 110 of system 100 may be one or more central processing units (CPUs), microprocessors, and/or other hardware devices suitable for retrieval and execution of instructions stored in machine-readable storage medium 120. Processor 110 may fetch, decode, and execute program instructions 121, 122, 123, and/or other instructions to enable radio health monitoring, as described below. As an alternative or in addition to retrieving and executing instructions, processor 110 may include one or more electronic circuits comprising a number of electronic components for performing the functionality of one or more of instructions 121, 122, 123, and/or other instructions.

In one example, the program instructions 121, 122, 123, and/or other instructions can be part of an installation package that can be executed by processor 110 to implement the functionality described herein. In this case, medium 120 may be a portable medium such as a CD, DVD, or flash drive or a memory maintained by a computing device from which the installation package can be downloaded and installed. In another example, the program instructions may be part of an application or applications already installed on system 100.

Non-transitory machine-readable storage medium 120 may be any hardware storage device for maintaining data accessible to system 100. For example, machine-readable storage medium 120 may include one or more hard disk drives, solid state drives, tape drives, and/or any other storage devices. The storage devices may be located in system 100 and/or in another device in communication with system 100. For example, machine-readable storage medium 120 may be any electronic, magnetic, optical, or other physical storage device that stores executable instructions. Thus, machine-readable storage medium 120 may be, for example, Random Access Memory (RAM), an Electrically-Erasable Programmable Read-Only Memory (EEPROM), a storage drive, an optical disc, and the like. As described in detail below, machine-readable storage medium 120 may be encoded with executable instructions for radio health monitoring. As detailed below, storage medium 120 may maintain and/or store the data and information described herein.

The operating issue determination instructions 121, when executed by processor 110, may determine whether a radio (e.g., radio 1 of FIG. 1) in a wireless network has a first operating issue of a set of operating issues. Information about the set of operating issues may be stored, for example, in non-transitory storage medium 120, and/or other storage medium of system 100. The set of operating issues may comprise high utilization, high noise floor, and/or other operating issues that may affect the efficiency of operation of the radio.

The operating issue determination instructions 121, when executed by processor 110, may determine that the radio has an operating issue based on monitoring the set of radios (e.g., radio 1, radio 2, . . . , radio N) that are communicably coupled via network 50. For example, the operating issue determination instructions 121, when executed by processor 110, may monitor the set of radios on a periodic, ongoing basis. The operating issue determination instructions 121, when executed by processor 110, may monitor the set of radios by reviewing batch feeds, neighbor information, and/or other information made available via network 50.

The batch feeds may be made available on a periodic basis (e.g., at predetermined time intervals or after a predetermined time interval has passed) and may contain information related to operation of the radio since the last batch feed was made available. A batch feed may be made available via broadcast over network 50, specifically to system 100 from the set of radios (e.g., radio 1, radio 2, radio N), and/or in some other manner. In some examples, a batch feed may also be made available responsive to a prompt from system 100 and/or may be made available in other manners.

In some examples, a batch feed may comprise, for each radio, statistics related to the radio and/or its performance. For example, a batch feed may comprise, for each radio, a status of the radio, an amount of bytes consumed since the last batch feed was made available, an output amount, a channel utilization metric, a sensed noised floor, an amount of multicast bytes transmitted, an amount of read/writes that occurred with data transmission, a transmission metric related to an amount of time the radio was transmitting data, a power metric, a radio metric indicating how many radios are on a channel, a mac address, a set of media types being transmitted, and/or other information related to the radio or an access point providing a channel for the radio.

Similar to batch feeds, neighbor information may be made available on a periodic basis, responsive to a prompt from system 100, and/or in another manner. Neighbor information may comprise information about a radio and its corresponding access point. For example, neighbor information may comprise information about the channel, a set of access points available to the radio on the channel, and/or other information related to the access point. Neighbor information can be used to allow the access point to act as a client and determine what is available to the access point via the channel. By allowing an access point to act as a client and obtain neighbor information via the access point, system 100 may determine if the channel is busy, overcrowded, dense, and/or encountering other issues. Responsive to determining that a number of access points of a same type on the channel exceeds a predetermined threshold, operating issue determination instructions 121, when executed by processor 110, may determine that there may be a deployment issue with the access point and/or radios on the channel. Responsive to determining that a number of access points of a different type on the channel exceeds a predetermined threshold, operating issue determination instructions 121, when executed by processor 110, may determine that there may be wi-fi interference issues experienced by the radio.

The operating issue determination instructions 121, when executed by processor 110, may identify a radio as a problem radio responsive to determining that the radio has high utilization and/or high floor noise, based on monitoring the set of radios. The operating issue determination instructions 121, when executed by processor 110, may determine a radio is a problem radio responsive to one or more of the monitored metrics exceeding a corresponding predetermined threshold. The monitored metric may comprise an attribute experienced by the radio.

In some examples, in a batch feed received every n minutes, where n is an integer greater than 0, operating issue determination instructions 121, when executed by processor 110, may determine a sample of metrics for each radio from the batch feed. For example, operating issue determination instructions 121, when executed by processor 110, may determine the sample of metrics for each radio for each minute experienced in the n minutes covered by the batch feed. The monitored metric may comprise an amount of time that the radio experienced the attribute being monitored, a percentage of time the radio experienced the attribute being monitored, a number of samples that included the attribute, a percentage of samples that included the attribute, and/or another measurement related to the radio experiencing the attribute.

For example, the monitored metrics may comprise a total records metric, a utilization metric, a noise floor metric, a non wi-fi interference metric, a wi-fi interference metric, a high physical event metric, a high CRC error metric, a multicast metric, a poor time metric, and/or other metrics related to radio performance.

The operating issue determination instructions 121, when executed by processor 110, may determine a total records metric for a radio by determining a total number of records received in the batch information for that radio. A record may comprise a single set of information associated with a timestamp for the radio in the batch feed.

The operating issue determination instructions 121, when executed by processor 110, may determine a utilization metric for a radio. The operating issue determination instructions 121, when executed by processor 110, may determine the utilization metric for the radio by determining a count of records where the channel utilization was greater than a predetermined utilization threshold. The operating issue determination instructions 121, when executed by processor 110, may obtain the predetermined utilization threshold from the storage medium 120, may determine a predetermined utilization threshold based on an average channel utilization of all records in the batch, may machine learn the predetermined utilization threshold based on a plurality of batch feeds, and/or may otherwise obtain the predetermined utilization threshold.

The operating issue determination instructions 121, when executed by processor 110, may determine a noise floor metric for a radio. The operating issue determination instructions 121, when executed by processor 110, may determine the noise floor metric for the radio by determining a count of records where the noise floor was greater than a predetermined noise floor threshold. The operating issue determination instructions 121, when executed by processor 110, may obtain the predetermined noise floor threshold from the storage medium 120, may determine a predetermined noise floor threshold based on an average noise floor of all records in the batch, may machine learn the predetermined noise floor threshold based on a plurality of batch feeds, and/or may otherwise obtain the predetermined noise floor threshold.

The operating issue determination instructions 121, when executed by processor 110, may determine a non wi-fi interference metric for a radio. The operating issue determination instructions 121, when executed by processor 110, may determine a non wi-fi interference for the radio by determining a count of records where a channel utilization amount was a predetermined non wi-fi threshold higher than a communication time of the radio. The operating issue determination instructions 121, when executed by processor 110, may determine a communication time of the radio by adding an amount of time that the radio was transmitting information and an amount of time that the radio was receiving information. The operating issue determination instructions 121, when executed by processor 110, may obtain the predetermined non wi-fi threshold from the storage medium 120, may machine learn the predetermined non wi-fi threshold based on a plurality of batch feeds, and/or may otherwise obtain the predetermined non wi-fi threshold.

The operating issue determination instructions 121, when executed by processor 110, may determine a wi-fi interference metric for a radio. The operating issue determination instructions 121, when executed by processor 110, may determine the wi-fi interference metric for the radio by determining that an issue exists with receiving information at the radio, the radio is spending a lot of time reading packets where the radio is not the final destination of the packet, and there may be an excess of access points competing for the same channel.

The operating issue determination instructions 121, when executed by processor 110, may determine that an issue exists with receiving information at the radio by determining that a ratio of time the radio spends receiving packets to a channel utilization of the radio is greater than a predetermined receipt threshold. The operating issue determination instructions 121, when executed by processor 110, may obtain the predetermined receipt threshold from the storage medium 120, may determine a predetermined receipt threshold based on an average ratio for all records in the batch, may machine learn the predetermined receipt threshold based on a plurality of batch feeds, and/or may otherwise obtain the predetermined receipt threshold.

The operating issue determination instructions 121, when executed by processor 110, may determine that the radio is spending a lot of time reading packets where the radio is not the final destination of the packet by determining whether a radio of the number of packets that the radio is reading compared to a number of packets that are destined for the radio is greater than a predetermined destination threshold. The operating issue determination instructions 121 when executed by processor 110, may obtain the predetermined destination threshold from the storage medium 120, may determine a predetermined destination threshold based on an average ratio for all records in the batch, may machine learn the predetermined destination threshold based on a plurality of batch feeds, and/or may otherwise obtain the predetermined destination threshold.

The operating issue determination instructions 121, when executed by processor 110, may determine that there may be an excess of access points competing for the same channel by determining, from neighbor information, whether a number of access points competing on the same channel as the radio is greater than a predetermined access point threshold. The operating issue determination instructions 121, when executed by processor 110, may determine that an access point may be competing on the channel based on the access point being configured to facilitate communication via the channel. The operating issue determination instructions 121, when executed by processor 110, may obtain the predetermined access point threshold from the storage medium 120, may determine a predetermined access point threshold based on an average number of access points using a channel for all records in the batch, may machine learn the predetermined access point threshold based on a plurality of batch feeds, and/or may otherwise obtain the predetermined access point threshold.

The operating issue determination instructions 121, when executed by processor 110, may determine a high physical event metric for a radio. The operating issue determination instructions 121, when executed by processor 110, may determine the high physical event metric for the radio by determining a count of records where an amount of physical events exceeds a predetermined physical events threshold. Each packet that is communicated by a radio comprises a MAC header, a physical header. The physical header includes information about the number of times the packet was opened to be read. The amount of physical events comprises the number of times packets in the record were read (based on the physical header of the packet). The operating issue determination instructions 121, when executed by processor 110, may obtain the predetermined physical events threshold from the storage medium 120, may determine a predetermined physical events threshold based on an average number of physical events experienced in the batch, may machine learn the predetermined physical events threshold based on a plurality of batch feeds, and/or may otherwise obtain the predetermined physical events threshold.

The operating issue determination instructions 121, when executed by processor 110, may determine a high CRC error metric for a radio. The operating issue determination instructions 121, when executed by processor 110, may determine the high CRC error metric for the radio by determining a count of records where the CRC errors are greater than a predetermined CRC threshold. A CRC error occurs when a packet is not able to be read when it is opened. The operating issue determination instructions 121, when executed by processor 110, may obtain the predetermined CRC threshold from the storage medium 120, may determine a predetermined CRC threshold based on an average number of CRC errors experienced in the batch, may machine learn the predetermined CRC threshold based on a plurality of batch feeds, and/or may otherwise obtain the predetermined CRC threshold.

The operating issue determination instructions 121, when executed by processor 110, may determine a multicast metric for a radio. The operating issue determination instructions 121, when executed by processor 110, may determine the multicast metric for the radio by determining where transmission time exceeds receiving time for the radio and where the radio is spending an excessive amount of transmission time performing multicast transmission. The operating issue determination instructions 121, when executed by processor 110, may determine that transmission time exceeds receiving time for the radio by determining that a ratio of an amount of time that the radio spends transmitting packets to an amount of time that the radio spends receiving packets exceeds a predetermined transmission threshold. The operating issue determination instructions 121, when executed by processor 110, may obtain the predetermined transmission threshold from the storage medium 120, may determine a predetermined transmission threshold based on an average ratio experienced in the batch, may machine learn the predetermined transmission threshold based on a plurality of batch feeds, and/or may otherwise obtain the predetermined transmission threshold. The operating issue determination instructions 121, when executed by processor 110, may determine that the radio is spending an excessive amount of transmission time performing multicast transmission by determining whether a ratio of an amount of time the radio is performing multicast communication to an amount of time the radio is transmitting packets exceeds a predetermined multicast threshold. The operating issue determination instructions 121, when executed by processor 110, may obtain the predetermined multicast threshold from the storage medium 120, may determine a predetermined multicast threshold based on an average ratio experienced in the batch, may machine learn the predetermined multicast threshold based on a plurality of batch feeds, and/or may otherwise obtain the predetermined multicast threshold.

The operating issue determination instructions 121, when executed by processor 110, may determine a poor time metric for each radio by determining a ratio of a total number of counts of records that contributed to one of the other metrics to a total number of records for the radio in the batch feed.

The operating issue determination instructions 121, when executed by processor 110, may save the determined metrics for each radio in the storage medium 120, may make the determined metrics for each radio available to a radio or other device in the network, and/or may otherwise handle the determined metrics.

Responsive to the poor time metric for the radio exceeding a predetermined poor time threshold, the operating issue determination instructions 121, when executed by processor 110, may determine that the radio has an operating issue and may determine a root cause for the operating issue. In some examples, the operating issue determination instructions 121, when executed by processor 110, may determine that the radio has an operating issue of high interference responsive to the radio having a utilization metric above the predetermined utilization threshold. In some examples, the operating issue determination instructions 121, when executed by processor 110, may determine that the radio has an operating issue of high noise floor responsive to the radio having a noise floor metric above the predetermined noise floor threshold

Root cause determination instructions 122, when executed by processor 110, may determine a respective root cause of a high utilization or high floor noise issue of a radio responsive to the operating issue determination instructions 121, when executed by processor 110, determines that the radio has an operating issue of high utilization or high noise floor.

Responsive to a determination that a radio is experiencing high utilization, the root cause determination instructions 122, when executed by processor 110, may determine a root cause for the high utilization.

The root cause determination instructions 122, when executed by processor 110, may determine that the root cause of the high utilization of the radio comprises a high noise floor responsive to determining that the non wi-fi metric for the radio exceeds the predetermined non wi-fi threshold and the noise floor metric exceeds the predetermined noise floor threshold.

The root cause determination instructions 122, when executed by processor 110, may determine that the root cause of the high utilization comprises high physical events in a few scenarios. For example, the root cause determination instructions 122, when executed by processor 110, may determine that the root cause of the high utilization comprises high physical events responsive to determining that the non wi-fi metric for the radio exceeds the predetermined non wi-fi threshold and the high physical event metric exceeds the predetermined physical events threshold. The root cause determination instructions 122, when executed by processor 110, may also determine that the root cause of the high utilization comprises high physical events responsive to determining that the wi-fi interference metric exceeds the predetermined wi-fi threshold and the high physical event metric exceeds the predetermined physical events threshold.

The root cause determination instructions 122, when executed by processor 110, may determine that the root cause of the high utilization comprises CRC errors in a few scenarios. For example, the root cause determination instructions 122, when executed by processor 110, may determine that the root cause of the high utilization comprises CRC errors responsive to determining that the non wi-fi metric for the radio exceeds the predetermined non wi-fi threshold and the CRC error metric exceeds the predetermined CRC threshold. The root cause determination instructions 122, when executed by processor 110, may also determine that the root cause of the high utilization comprises CRC errors responsive to determining that the wi-fi interference metric exceeds the predetermined wi-fi threshold and the CRC error metric exceeds the predetermined CRC threshold.

The root cause determination instructions 122, when executed by processor 110, may determine that the root cause of the high utilization comprises non wi-fi interference responsive to determining that the non wi-fi metric for the radio exceeds the predetermined non wi-fl threshold and no other metrics exceeding their respective thresholds.

The root cause determination instructions 122, when executed by processor 110, may determine that the root cause of the high utilization comprises high multicast responsive to determining that the wi-fi interference metric exceeds the predetermined wi-fi threshold and the multicast metric exceeds the predetermined multicast threshold.

The root cause determination instructions 122, when executed by processor 110, may determine that the root cause of the high utilization comprises wi-fi interference responsive to determining that the wi-fi interference metric exceeds the predetermined wi-fi threshold and no other metrics exceeding their predetermined thresholds.

Responsive to a determination that a radio is experiencing high floor noise, the root cause determination instructions 122, when executed by processor 110, may determine a root cause for the high floor noise.

The root cause determination instructions 122, when executed by processor 110, may determine that the root cause of the high floor noise comprises high physical events responsive to determining that the floor noise metric for the radio exceeds the predetermined floor noise threshold, the non wi-fi metric exceeding the predetermined non wi-fi threshold, and the high physical event metric exceeds the predetermined physical events threshold.

The root cause determination instructions 122, when executed by processor 110, may determine that the root cause of the high floor noise comprises CRC errors responsive to determining that the floor noise metric for the radio exceeds the predetermined floor noise threshold, the non wi-fi metric exceeding the predetermined non wi-fi threshold, and the CRC error metric exceeds the predetermined CRC threshold.

The root cause determination instructions 122, when executed by processor 110, may determine that the root cause of the high floor noise is unknown responsive to the floor noise metric for the radio exceeds the predetermined floor noise threshold, the non wi-fi metric exceeding the predetermined non wi-fi threshold, and no other metrics being exceeded.

The root cause determination instructions 122, when executed by processor 110, may store information about the determined root cause for the radio in the storage medium 120. The information may comprise, for example, the determined operating issue (e.g., high utilization or high floor noise), the determined root cause, the determined metrics, and/or other information related to the radio.

Responsive to determining a root cause for the determined operating issue, alert providing instructions 123, when executed by processor 110, may provide an alert comprising information about the radio, the determined operating issue, and the determined root cause. The alert providing instructions 123, when executed by processor 110, may provide the alert to network administrators, to network servers, to access points, radios, and/or other entities. In some examples, the alert providing instructions 123, when executed by processor 110, may provide an alert responsive to the radio experiencing at least a predetermined threshold of metrics exceeding their respective thresholds. In some examples, the alert may comprise information about each radio for which an operating issue was determined based on the batch information and the neighbor information.

FIG. 2 is a block diagram of an example system 200 for radio health monitoring. As with system 100, system 200 may comprise a radio, access point, wireless server, mainframe, notebook, desktop, tablet, workstation, mobile device, network controller, and/or any other device suitable for executing the functionality described below. As with processor 110 of FIG. 1, processor 210 may be one or more CPUs, microprocessors, and/or other hardware devices suitable for retrieval and execution of instructions.

As detailed below, system 200 may include a series of engines 220-240 for radio health monitoring. Each of the engines may generally represent any combination of hardware and programming. For example, the programming for the engines may be processor executable instructions stored on a non-transitory machine-readable storage medium and the hardware for the engines may include at least one processor of the system 200 to execute those instructions. In addition or as an alternative, each engine may include one or more hardware devices including electronic circuitry for implementing the functionality described below.

Operating issue determination engine 220 may determine whether a radio in a wireless network has high utilization and/or high floor noise. In some examples, the operating issue determination engine 220 may determine whether the radio has high utilization and/or high floor noise in a manner the same as or similar to that of the operating issue determination instructions 122 of system 100. Further details regarding an example implementation of operating issue determination engine 220 are provided above in connection with operating issue determination instructions 121 of FIG. 1.

Root cause determination engine 230 may determine a root cause for the high utilization and/or high floor noise responsive to the determination that the radio has high utilization and/or high floor noise. In some examples, the root cause determination engine 230 may determine the root cause in a manner the same as or similar to that of the root cause determination instructions 122 of system 100. Further details regarding an example implementation of root cause determination engine 230 are provided above in connection with root cause determination instructions 122 of FIG. 1.

Alert providing engine 240 may provide an alert comprising information about the radio, the determined high utilization and/or high noise floor, and the determined root cause. In some examples, the alert providing engine 240 may provide the alert in a manner the same as or similar to that of the alert providing instructions 123 of system 100. Further details regarding an example implementation of alert providing engine 240 are provided above in connection with alert providing instructions 123 of FIG. 1.

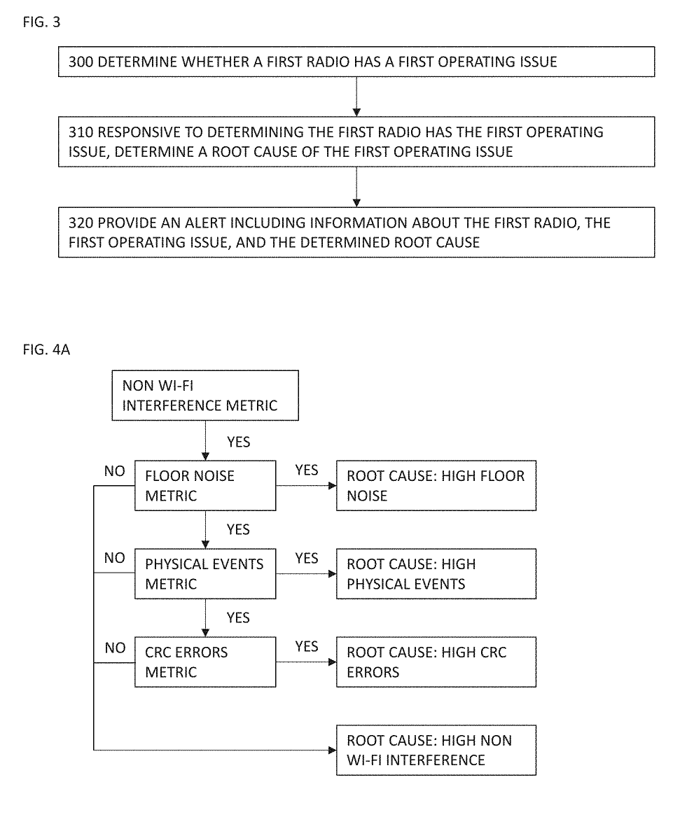

FIG. 3 is a flowchart of an example method for execution by a computing device for radio health monitoring.

Although execution of the methods described below are with reference to system 100 of FIG. 1, and/or system 200 of FIG. 2, other suitable devices for execution of this method will be apparent to those of skill in the art. The method described in FIG. 3 and other figures may be implemented in the form of executable instructions stored on a machine-readable storage medium, such as storage medium 120, by one or more engines described herein, and/or in the form of electronic circuitry.

In an operation 300, a determination may be made, for a first radio in a set of radios in a wireless network, as to whether the radio has a first operating issue (e.g. high utilization and/or high noise floor). For example, the system 100 (and/or the operating issue determination instructions 121, the operating issue determination engine 220, or other resource of the system 100) may determine whether the radio has an operating issue. The system 100 may determine whether the radio has an operating issue in a manner similar or the same as that described above in relation to the execution of the operating issue determination instructions 121, the operating issue determination engine 220, and/or other resource of the system 100.

In an operation 310, responsive to determining that the radio has an operating issue, the root cause of the operating issue may be determined. For example, the system 100 (and/or the root cause determination instructions 122, the root cause determination engine 220, or other resource of the system 100) may determine the root cause. The system 100 may determine the root cause in a manner similar or the same as that described above in relation to the execution of the root cause determination instructions 122, the root cause determination engine 220, and/or other resource of the system 100.

In an operation 320, an alert may be provided, where the alert includes information about the radio, the operating issue (e.g., the high utilization and/or high floor noise), and the determined root case. For example, the system 100 (and/or the alert providing instructions 123, the alert providing engine 240, or other resource of the system 100) may obtain the first amount of data. The system 100 may provide the alert in a manner similar or the same as that described above in relation to the execution of the alert providing instructions 123, the alert providing engine 240, and/or other resource of the system 100.

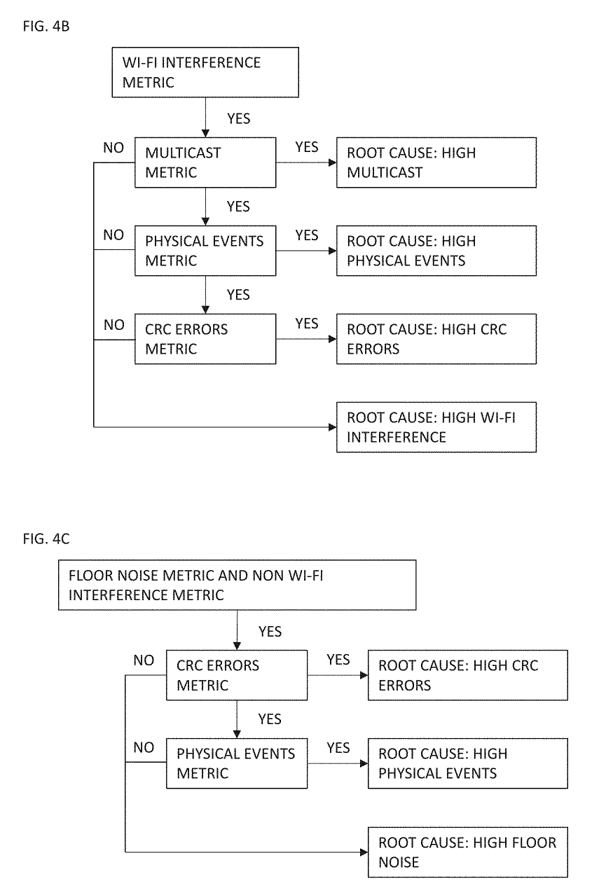

FIGS. 4A, 4B, and 4C are flowcharts of an example method for execution by a computing device for radio health monitoring. In particular, FIGS. 4A, 4B, and 4C are flowcharts showing how root cause of an operating issue is determined. FIGS. 4A and 4B depict flowcharts showing example root cause determination for the determined operating issue of high utilization, and FIG. 4C depicts a flowchart showing example root cause determination of an operating issue of high floor noise.

In an example of FIG. 4A, responsive to system 100 determining that the operating issue of high utilization exists for a radio, the system 100 may first determine that the non wi-fi interference metric exceeds the predetermined non wi-fi threshold. Responsive to the non wi-fi threshold being exceeded, the system 100 may determine whether other metrics are exceeded to determine the root cause for the high utilization. For example, the system 100 may determine whether the floor noise metric exceeds the predetermined floor noise metric. Responsive to the predetermined floor noise threshold being exceeded, the system 100 may determine that the root cause for the high utilization of the radio is floor noise. Responsive to the floor noise metric not exceeding the predetermined floor noise threshold, the system 100 may determine whether the physical events metric exceeds the predetermined physical events threshold. Responsive to the predetermined physical events threshold being exceeded, the system 100 may determine that the root cause for the high utilization is physical events. Responsive to the predetermined physical events threshold not being exceeded, the system 100 may determine whether the CRC error metric exceeds the predetermined CRC threshold. Responsive to the predetermined CRC error threshold being exceeded, the system 100 may determine that the root cause for the high utilization is CRC errors. Responsive to the predetermined CRC error threshold not being exceeded, the system 100 may determine that the root cause for the high utilization of the radio is non wi-fi interference.

In another example of FIG. 4B, responsive to system 100 determining that the operating issue of high utilization exists for a radio, the system 100 may first determine that the wi-fi interference metric exceeds the predetermined wi-fi threshold. Responsive to the wi-fi threshold being exceeded, the system 100 may determine whether other metrics are exceeded to determine the root cause for the high utilization. For example, the system 100 may determine whether the multicast metric exceeds the predetermined multicast metric. Responsive to the predetermined multicast threshold being exceeded, the system 100 may determine that the root cause for the high utilization of the radio is multicast issues. Responsive to the multicast metric not exceeding the predetermined multicast threshold, the system 100 may determine whether the physical events metric exceeds the predetermined physical events threshold. Responsive to the predetermined physical events threshold being exceeded, the system 100 may determine that the root cause for the high utilization is physical events. Responsive to the predetermined physical events threshold not being exceeded, the system 100 may determine whether the CRC error metric exceeds the predetermined CRC threshold. Responsive to the predetermined CRC error threshold being exceeded, the system 100 may determine that the root cause for the high utilization is CRC errors. Responsive to the predetermined CRC error threshold not being exceeded, the system 100 may determine that the root cause for the high utilization of the radio is wi-fi interference.

In another example of FIG. 4C, responsive to system 100 determining that the operating issue of high floor noise exists for a radio, the system 100 may first determine that the non wi-fi interference metric exceeds the predetermined non wi-fi threshold and the floor noise metric exceeds the predetermined floor noise metric. Responsive to the predetermined floor noise threshold and the predetermined non wi-fi threshold being exceeded, the system 100 may determine whether other metrics are exceeded to determine the root cause for the high floor noise. For example, the system 100 may determine whether the physical events metric exceeds the predetermined physical events threshold. Responsive to the predetermined physical events threshold being exceeded, the system 100 may determine that the root cause for the high floor noise is physical events. Responsive to the predetermined physical events threshold not being exceeded, the system 100 may determine whether the CRC error metric exceeds the predetermined CRC threshold. Responsive to the predetermined CRC error threshold being exceeded, the system 100 may determine that the root cause for the high utilization is CRC errors. Responsive to the predetermined CRC error threshold not being exceeded, the system 100 may determine that the root cause for the high floor noise of the radio is unknown.

The foregoing disclosure describes a number of examples of radio health monitoring. The disclosed examples may include systems, devices, computer-readable storage media, and methods for radio health monitoring. For purposes of explanation, certain examples are described with reference to the components illustrated in FIGS. 1-4C. The functionality of the illustrated components may overlap, however, and may be present in a fewer or greater number of elements and components. Further, all or part of the functionality of illustrated elements may co-exist or be distributed among several geographically dispersed locations. Moreover, the disclosed examples may be implemented in various environments and are not limited to the illustrated examples.

Further, the sequence of operations described in connection with FIGS. 1-4C are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples. All such modifications and variations are intended to be included within the scope of this disclosure and protected by the following claims.

We claim:

1. A system for radio health monitoring, the system comprising:
a physical processor implementing machine readable instructions stored on a non-transitory machine-readable storage medium that cause the system to:
determine whether a radio in a wireless network has high utilization;
responsive to determining that the radio has high utilization, determine a root cause for the high utilization; and
provide an alert comprising information about the radio, the high utilization, and the determined root cause.

2. The system of claim 1, wherein the physical processor implements machine readable instructions that cause the system to:
determine that the radio has high utilization based on wi-fi interference experienced by the radio and non wi-fi interference experienced by the radio.

3. The system of claim 2, wherein the physical processor implements machine readable instructions that cause the system to:
determine whether the wi-fi interference experienced by the radio exceeds a wi-fi predetermined threshold;
responsive to the wi-fi interference experienced by the radio exceeding the wi-fi predetermined threshold, determine the root cause of the high utilization based on at least one of: physical events experienced by the radio, multicast functionality experienced by the radio, or CRC errors experienced by the radio.

4. The system of claim 2, wherein the physical processor implements machine readable instructions that cause the system to:
determine whether the non wi-fi interference experienced by the radio exceeds a non wi-fi predetermined threshold;
responsive to the non wi-fi interference experienced by the radio exceeding the non wi-fi predetermined threshold, determine the root cause of the high utilization based on at least one of: high floor noise experienced by the radio, physical events experienced by the radio, or CRC errors experienced by the radio.

5. The system of claim 1, wherein the physical processor implements machine readable instructions that cause the system to:
determine whether the radio in the wireless network has high floor noise;
responsive to determining that the radio has high floor noise, determine a floor noise root cause for the high floor noise; and
provide an alert comprising information about the radio, the high floor noise, and the determined floor noise root cause.

6. The system of claim 5, wherein the physical processor implements machine readable instructions that cause the system to:
determine that the radio has high floor noise based on floor noise experienced by the radio and non wi-fi interference experienced by the radio; and
determine the root cause of the high floor noise based on at least one of: physical events experienced by the radio, or CRC errors experienced by the radio.

7. The system of claim 6, wherein the physical processor implements machine readable instructions that cause the system to:
determine the root cause of the high floor noise based on physical events experienced by the radio by:
determining whether a measure of time during which the radio experienced physical events exceeds a predetermined physical radio threshold.

8. The system of claim 1, wherein the physical processor implements machine readable instructions that cause the system to:
receive information about the radio at predetermined intervals; and
determine whether the radio has high utilization based on the received information.

9. A method for radio health monitoring, the method being implemented by a network comprising a physical processor implementing computer readable instructions, the method comprising:
determining, for a first radio in a set of adios in a wireless network, whether the first radio has high floor noise;
responsive to determining that the first radio has high floor noise, determining a root cause of the floor noise; and
providing an alert comprising information about the first radio, the high floor noise, and the determined root cause.

10. The method of claim 9, further comprising:
determining that the first radio has high floor noise based on floor noise experienced by the first radio and non wi-fi interference experienced by the first radio.

11. The method of claim 10, further comprising:
determining the root cause of the high floor noise based on at least one of: physical events experienced by the first radio, or CRC errors experienced by the first radio.

12. The method of claim 9, further comprising:
receiving information about the radio at predetermined intervals; and
determining whether the radio has high floor noise based on the received information.

13. The method of claim 9, further comprising:
determining, for the first radio in the set of radios, whether the first radio has high utilization based on wi-fi interference experienced by the radio and non wi-fi interference experienced by the radio;
responsive to determining that the first radio has high utilization, determining a root cause of the utilization; and
providing an alert comprising information about the first radio, the high utilization, and the determined root cause
determining that the first radio has high utilization based on wi-fi interference experienced by the first radio and non wi-fi interference experienced by the first radio.

14. The method of claim 13, further comprising:
determining whether the wi-fi interference experienced by the first radio exceeds a wi-fi predetermined threshold; and
responsive to the wi-fi interference experienced by the first radio exceeding the wi-fi predetermined threshold, determining the root cause of the utilization based on at least one of: physical events experienced by the first radio, multicast functionality experienced by the first radio, or CRC errors experienced by the first radio.

15. A non-transitory machine-readable storage medium comprising instructions for radio health monitoring, the instructions executable by a physical processor of a system to:
determine, for a set of radios in a wireless network, whether each radio in the set of radios has an operating issue from a set of operating issues, wherein the set of operating issues comprise high utilization and high floor noise;
responsive to determining that a first radio of the set of radios has a first operating issue of the set of operating issues, determine a root cause of the first operating issue of the first radio; and
provide an alert comprising information about the first radio, the first operating issue, and the determined root cause.

16. The non-transitory machine-readable storage medium of claim 15, further comprising instructions executable by the physical processor to:
determine whether a first radio of the set of radios has high utilization based on wi-fi interference experienced by the first radio and non wi-fi interference experienced by the first radio; and
determine that the first radio has high floor noise experienced by the radio and non wi-fi interference experienced by the first radio.

17. The non-transitory machine-readable storage medium of claim 16, further comprising instructions executable by the physical processor to:
receive information about the radio at predetermined intervals; and
determine, based on the received information, whether the first radio experienced on or more of: wi-fi interference, non wi-fi interference, or floor noise.

18. The non-transitory machine-readable storage medium of claim 17, further comprising instructions executable by the physical processor to:
determine that the root cause of the high utilization is based on non wi-fi interference responsive to determining that the first radio did not experience high noise floor, a number of physical events exceeding a predetermined physical events threshold, and a count of CRC errors exceeding a predetermined CRC error threshold.

19. The non-transitory machine-readable storage medium of claim 17, further comprising instructions executable by the physical processor to:
determine that the root cause of the high noise floor is unknown responsive to determining that the first radio did not experience a number of physical events exceeding a predetermined physical events threshold, and a count of CRC errors exceeding a predetermined CRC error threshold.

20. The non-transitory machine-readable storage medium of claim 15, further comprising instructions executable by the physical processor to;
store, for each radio in the set of radios, a respective set of operating issues experienced by the first radio;
determine a respective root cause for each operating issue of a respective set of operating issues for a radio; and
provide an alert comprising information about the radio, each operating issue experienced by the radio, and the corresponding determined root cause.
